(19) United States
(12) Patent Application Publication
(10) Pub. No.: US 2006/0172041 A1
(43) Pub. Date: Aug. 3, 2006

(54) Magnetic aerator

(76) Inventor: Patrick L. Farrell, Huntington Beach, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/046,468

(22) Filed: Jan. 28, 2005

(51) Int. Cl. A21D 13/00

(52) U.S. Cl. 426/95

(57) ABSTRACT

A magnetic aerator includes a liquid agitating blade insertable into a hand held beverage container along with a magnet disposed at the blade with the magnet introducing a magnetic field into the liquid. A finger manipulatable stem supports the blade and enables manual agitation of the liquid by the blade approximate a surface of the liquid.

The present invention generally relates devices and methods for improving the organoleptic properties of beverages and is more particularly directed a device and method for exposing poured or decanted beverages to a magnetic field and aerating same immediately prior to consumption. With regard to alcoholic beverages, the present invention reduces the perception of tannins and acid. Such alcoholic beverages include wine, brandies, Sherries, ports, cognac, spirits, beer, and any other alcoholic beverage.

Besides the tannins in wine, there are polyphenolic compounds in coffee, tea, fruit juice, and vegetable juice. The production processes of these beverages in such that the polyphenolic compounds found in coffee beans, tea leaves, fruit skins and seeds, and vegetable skins and seeds are extracted into the beverages, either by the action of heat, enzymes, mechanical action, or combination thereof. These compounds have become increasingly investigated and are integral to the health promoting properties of some of these beverages.

As such, there is a trend to increase such polyphenolic compounds in such beverages. The downside of such extraction is that bitterness is a side effect of such polyphenols and the processing process. These tannins and polyphenols also tend to obscure the underlying flavors of the coffee, tea, wine, spirits, beer, fruit juice, and vegetable juice.

As is well known, tannins are harsh, bitter, astringent, and dry tasting compounds in wines which are caused by grape skins, seeds, stems, or the use of wood, such as in barrels, staves, or chips, which often are utilized for the aging of wine or to impart desired taste characteristics to alcoholic beverages, including wines, fortified wines, and whiskeys.

As is also well known in wines, such tannins polymerize during aging and accordingly older wines generally have a softer texture, smoother, and fruiter taste than the same wine at a younger age.

The use of magnets to alter the composition of tannins in alcoholic beverages, particularly wine, has been known for some time. For example, as early as 1900, magnetic drinking cups were developed, see U.S. Pat. No. 655,413. U.S. Pat. No. 4,872,401 provides for a device for improving the flavor or removing the piquant flavor of fermented products utilizing a container with surrounding walls having magnets disposed thereon. In this manner, the composition of the tannins is altered so as to make the perception of astringency less.

U.S. Pat. No. 5,556,654 provides for passing a liquid through a magnetic field in order to enhance the flavor of the liquid utilizing tubular permanent magnets for treating a liquid prior to bottling thereof.

U.S. Pat. No. 5,860,353 provides for apparatus and a method for accelerating aging of alcoholic liquids such as wines, brandies, spirits, and the like within bottles disposed in a rack.

U.S. Pat. No. 6,287,614 utilizes a coaster having a magnet for improving the organoleptic properties of alcohol in a bottle.

U.S. Pat. No. 6,390,319 provides for a beverage container having a volume exposed to magnetic fields.

U.S. Patent Application 2003/0003189 A1 provides for establishing a magnetic field within a bottle in order to cause certain molecules in the wine to flow from the bottom of the bottle to the top in a constant motion along the flux lines of the magnetic field between the bottom and the top of the magnet.

U.S. Pat. No. 6,733,434 provides for a method for restructuring an ingestible substance and constituents thereof by providing magnetic fields of specific flux densities.

U.S. Patent Application Serial No. 2003/0226447 A1 provides for a beverage flavor enhancing device having a base and a plurality of tubular members extending upwardly from the base and arrange in a spaced apart relationship to receive the beverage container and subject any container to a magnetic field.

U.S. Pat. No. 1,546,510, 2,951,689, 3,854,704, 4,162,129, 4,494,452, 6,332,706, and 6,703,055 relate to the aeration of beverages in containers utilizing mechanisms not suited for poured or decanted beverages.

It is clear that none of the hereinabove developed devices provide a convenient means for an end user, such as a wine connoisseur, to conveniently and selectively magnetically treat wine or other alcoholic beverage without extensive apparatus or without treating an entire bottle of alcoholic beverage. It should be clear that if an entire bottle is treated with a magnetic field to effect the organoleptic qualities of the beverage contained therein there can be no real specific comparison of treated and untreated beverage from the same bottle.

The present invention provides for an aerator for enabling selective magnetic treatment of alcoholic beverages which is convenient, simple to use, and does not require extensive equipment or the treatment of whole bottles of alcoholic beverage. The aerator in accordance with the present invention is simple in design and the effects are noted immediately as, for example, wine is exposed to both a magnetic field and to oxygen. The present invention affords the ability to titrate the effect obtained from aeration and exposure to the magnetic field.

### SUMMARY OF THE INVENTION

A magnetic aerator in accordance with the present invention generally includes a liquid agitating blade insertable into a hand held beverage container along with a magnet disposed at the blade with the magnet introducing a magnetic field into the liquid.

A finger manipulatable stem is provided and supports the blade for enabling manual agitation of the liquid by the blade proximate a surface of the liquid. This surface agitation not only introduces a magnetic field but also incorporates beneficial oxygen into the beverage, such as, for example, wine.

More particularly, the magnet may be disposed within the blade and another embodiment of the present invention, a plurality of blades, preferably two, are provided for agitating the beverage within the container. In this embodiment, preferably the blades are parallel to one another and of opposite plurality.

A method in accordance with the present invention for improving the organoleptic properties of a beverage generally includes pouring a beverage into a container suitable for drinking therefrom and thereafter introducing a magnet proximate a surface of the beverage within the container and agitating the magnet to aerate and stir the beverage while at the same time exposing the beverage to a magnetic field.

More particularly, the method in accordance with the present invention includes utilizing a finger manipulated stem attached to the magnet.

Accordingly, the device and method in accordance with the present invention enhances the organoleptic properties of the alcoholic beverage by exposure to oxygen in the air while simultaneously treating the beverage with the magnetic field. Any number of magnets may be utilized however such a magnet should be disposed for enhancing the magnetic field therebetween.

### BRIEF DESCRIPTION OF THE DRAWINGS

The advantages and features of the present invention will be better understood by the following description when considered in conjunction with the accompanying drawings in which:

FIG. 1 is a perspective view of a magnetic aerator in accordance with the present invention generally showing a liquid agitating blade, a finger manipulatable stem supporting the blade, and a handle;

FIG. 2 is a cross section of the blade taken along the line 2-2 of FIG. 1 generally illustrating a magnet disposed at the blade, preferably encapsulated by a plastic coat and illustrating a magnetic field established by the magnet;

FIG. 3 is an illustration of the method of the present invention for removing organoleptic properties of beverage which include pouring a beverage into a container and introducing a magnet proximate a surface of the beverage within the container and agitating the magnet to aerate and stir the beverage; and

FIG. 4 is an alternative embodiment in accordance with the present invention of a magnetic aerator having a plurality of liquid agitating blades.

### DETAILED DESCRIPTION

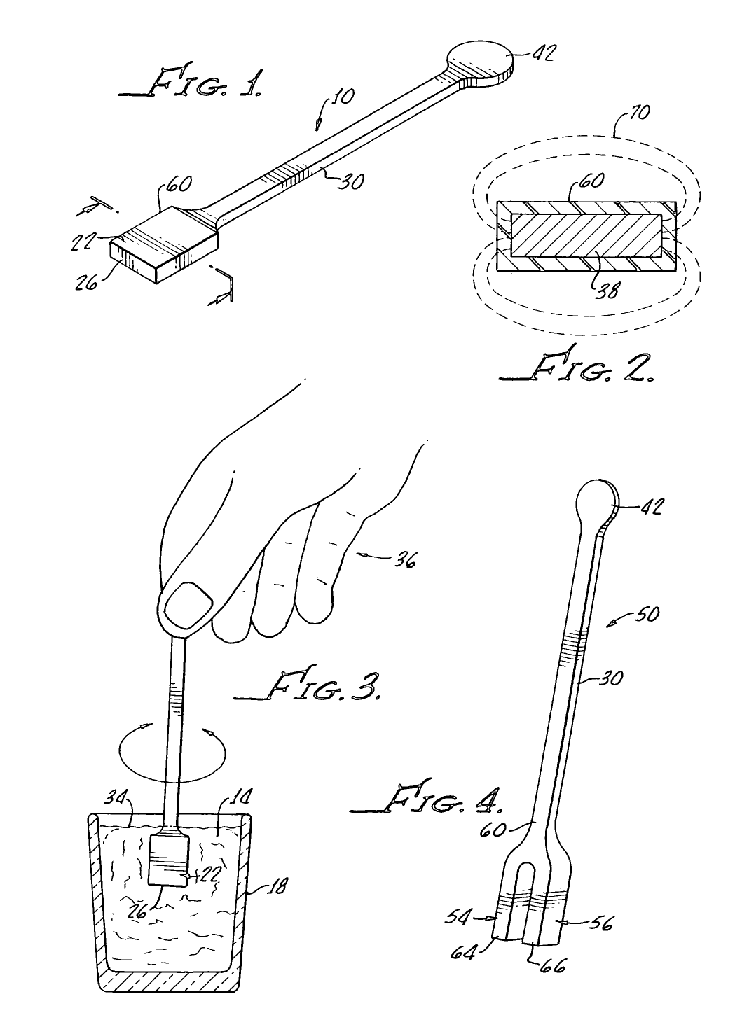

With reference to FIGS. 1-3, there is shown a magnetic aerator 10 in accordance with the present invention shown as it may be utilized with a beverage 14 poured into a container 18 for drinking therefrom for improving the organoleptic properties of the beverage. As shown, the aerator 10 includes a liquid agitating blade 22 while being sized for insertion into the hand held beverage container 18, which may be a glass, paper cup, or the like, alternative containers not being shown for the sake of clarity.

The blade 22 includes a base 26 wider than a finger manipulatable stem 30 for promoting aeration and agitation of the beverage 14 when manipulated proximate to a surface 34 of the beverage within the container 18, the agitation being enabled by the stem 30 through finger 36 manipulation thereof.

A permanent magnet 38 best shown in FIG. 2 is provided at the blade 22 and preferably encapsulated within the blade 22 by an FDA approved food-group plastic 60 which also coats the stem 30 and optional handle 42.

The permanent magnet 38 may be of any suitable type from, for example, iron, steel, or rare earth, such as neodymium, or alnico, etc.

With a reference to FIG. 4, there is shown an alternative embodiment aerator 50 with common character references representing identical or substantially similar elements as shown in FIGS. 1-3 in the description of the aerator 10.

The aerator 50 includes two spaced apart parallel blades 54, 56 and include either magnets 64, 66 of opposite plurality or a U-shape magnet enclosed within a plastic coating 60.

Principles of operation of the aerator 52 is substantially the same as the aerator 10 and includes the method in accordance with the present invention of pouring a beverage into the container 18 introducing the magnet 38, 64, 66 proximate a surface of the beverage 14 within the container 18 and agitating the magnet 38, 64, 66, to both aerate and stir the beverage 14.

The beverage 14, as it encounters a strong magnetic field 70 of the aerator 10, causes an alteration in the configuration of the charged particles that impart bitterness in these beverages such as coffee or tea dispenser, fruit juice, vegetable juice, spirits and beer.

With immediate exposure to air, chemical changes occur to the structure and configuration of these polyphenols and other chemical so as to make the beverages taste less bitter and less astringent. Underlying flavors inherent to the beverage become unmasked and the beverage is perceived to taste more flavorful and smoother.

In the case of tannic red wines, the perception is that of fruitier and softer. In the case of coffee or tea, the perception is one of enhanced flavor, increased richness, decreased bitterness and decreased astringency.

As per the wine experiments, this effect has been observed in a blind tasting fashion by the inventors and others. Repeatedly, most tasters prefer the sample treated with the magnetic pourer. As per the wine experiments, this effect requires the strong magnetic field and immediate exposure to oxygen. Without oxygen, the softening effect upon the beverage is diminished.

### EXAMPLE 1

With regard to red wine and some oak matured white wines, the magnetic wine aerator 10 consistently renders wine in the glass fruitier, softer, and less astringent. This has been found consistently for a variety of red wines, most of recent vintages, and have includes wines from: California, Bordeaux, Rhone Valley, Piedmont, Tuscany, Spain, Washington State, Chile, Argentina, South Africa, and Australia. Varieties tested include: cabernet sauvignon, cabernet, franc, merlot, syrah, Grenache, Rhone blends, Bordeaux blends, pinot noir, zinfandel, sangiovese, barbera, nebbiolo, tempranillo, and malbec.

As expected for any taste preference, individuals vary with regard to their preferences. Some consistently prefer the magnetized wine, others consistently prefer non-magnetized wine, while a third group tended to prefer a blend of the two. Most preferred the magnetized wine for some examples, and non-magnetized wines for other samples poured. A generalization that can be made from the tasting experiments was that wines that were overly astringent to begin with, either from harsh tannins, excessive extraction of tannins, or being opened without sufficient bottle age, benefited the most from being stirred by the magnetic aerator 10.

Besides making red wines taste fruitier and softer, the magnetic aerator also made some red wines taste less vegetal, less herbaceous. A characteristic of less than ripe cabernet sauvignon (also cabernet franc, merlot, malbec, and syrah) is that of vegetal, herbaceous characteristics, including bell pepper, green peppercorns, quince, weediness. Winemakers go to great efforts in vineyard site selection, vineyard work, and winemaking techniques (such as micro-oxidation) to decrease these characters. The magnetic wine aerator 10 had a dramatic impact upon such wines, markedly decreasing the vegetal/herbaceous/weedy character of the wine, and thus significantly improving the taste profile. This was particularly true of Chilean wines and mass-produced red wines from California and France.

Proposed mechanisms, which include the polymerization and structural changes of tannins and anthocyanins in the wine, which can lead to decreased astringency and softer, fruitier wines have been discussed in the cited patents.

### EXAMPLE 2

Oxygen, via the process of decanting, or during oxidation production racking or micro-oxidation, greatly encourages softening of wines via such chemical changes involving tannins. As such, it is theorized that oxygen was playing a role with regard to device in accordance with the present invention. An experiment was conducted whereby wine was stirred, with the magnetic aerator in place, in an oxygen-free environment. The same wine was stirred in the presence of oxygen both with and without the magnet. A recent vintage Chilean cabernet sauvignon was the wine poured. The non-magnetized wine was harshly astringent from hard tannins. The magnetic poured, in the absence of oxygen, did soften the wine slightly. There was a marked difference when the wine was stirred by the magnetic aerator in the presence of oxygen. The wine was then made much less herbaceous, and much less astringent while having markedly improved fruit profile. This demonstrates that the combination of oxygen and the magnetic field work in concert to alter the chemistry of the wine to allow for a rapid softening and improvement of the fruit profile.

The aerator 10 is also effective with white wines. The magnetic aerator 10 reproducibly makes over-oaked wines, such as oaky chardonnay, far more approachable, less tannic, and fruiter. The same effect would be expected on other, heavily oaked white wines.

Although there has been hereinabove described a specific magnetic aerator with magnetic enhancement in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A magnetic aerator comprising:
a liquid agitating blade insertable into a hand held beverage container;
a magnet disposed at the blade, said magnet introducing a magnetic field into the liquid; and
a finger manipulatable stem supporting the blade and enabling manual agitation of the liquid by the blade proximate a surface of the liquid.

2. The magnetic aerator according to claim 1 wherein said magnet is disposed within the blade.

3. A magnetic aerator comprising:
a plurality of liquid agitating blades insertable into a hand held beverage container;
a magnet disposed at each of the blades, each magnet introducing a magnetic field into the liquid; and
a finger manipulatable stem supporting the blades and enabling manual agitation of the liquid by the blades proximate a surface of the liquid.

4. The magnetic aerator according to claim 3 wherein each magnet is disposed within a respective blade.

5. The magnetic aerator according to claim 3 wherein the blades are parallel with one another.

6. The magnet according to claim 5 comprising two liquid agitation blades.

7. The magnet aerator according to claim 6 wherein the magnets are of opposite plurality.

8. A method for improving organoleptic properties of a beverage, said method comprising:
pouring a beverage into a container suitable for drinking therefrom.
introducing a magnet proximate a surface of the beverage within said container; and
agitating the magnet to aerate and stir the beverage.

9. The method according to claim 8 wherein introducing a magnet includes using a finger manipulative stem attached to said magnet.

10. The method according to claim 9 wherein introducing a magnet further comprises introducing a pair of spaced apart magnets.
